(19) United States
(12) Patent Application Publication
(10) Pub. No.: US 2021/0282379 A1
(43) Pub. Date: Sep. 16, 2021

(54) LURE WITH MOVABLE HOOK

(71) Applicant: RMB Importing, LLC, Fort Atkinson, WI (US)

(72) Inventor: Robin Hancock, Elkhorn, WI (US)

(73) Assignee: RMB Importing, LLC, Fort Atkinson, WI (US)

(21) Appl. No.: 16/820,085

(22) Filed: Mar. 16, 2020

(51) Int. Cl. A01K 85/00

(52) U.S. Cl. CPC A01K 85/00

(57) ABSTRACT

A lure having a body with a hook that may move with respect to the body. In one embodiment, the hook is rotatably attached to the body such that the hook may rotate vertically. In another embodiment, the hook is rotatably attached to the body such that the hook may rotate horizontally. In another embodiment, the hook is attached to the body such that the point of the hook may slide closer to and further away from the body.

### FIELD OF THE INVENTION

The present invention relates generally to the field of fishing. More particularly, the present invention relates to the field of lures.

### BACKGROUND

Lures are used by fishing hobbyists and professionals to catch fish. Lures come in a wide variety of shapes, sizes and configurations and can often be relatively inexpensive. Further, lures are versatile in that they can be tailored to attract a particular type of fish by changing one or more characteristics, for example, the shape or size. One type of lure is called a jig. Many jigs have a hook fixedly attached to a body.

One aspect of an artificial bait that can make the bait appear lifelike is the sound and/or vibrations it makes. One attempt to create a lifelike eye in the fishing industry, as seen in U.S. Pat. Nos. 10,575,506 and 10,244,741, by the inventor and owned by the owner of the present application, which are hereby incorporated herein for all purposes, was to use one or more balls in an enclosed housing. As the lure moves in the water, the ball(s) move from one side of the housing to the other creating a life-like appearance and a clicking sound as the contact each other and the ends of the housing.

It will be understood by those skilled in the art that one or more aspects of this invention can meet certain objectives, while one or more other aspects can lead to certain other objectives. Other objects, features, benefits and advantages of the present invention will be apparent in this summary and descriptions of the disclosed embodiment, and will be readily apparent to those skilled in the art. Such objects, features, benefits and advantages will be apparent from the above as taken in conjunction with the accompanying figures and all reasonable inferences to be drawn therefrom.

### BRIEF DESCRIPTION OF THE DRAWINGS

FIG. 1 is a side perspective view of one embodiment of a lure.

FIG. 2 is a side elevation view of the lure in FIG. 1 with the hook up.

FIG. 3 is a top plan view of the lure in FIG. 1 with the hook down.

FIG. 4 is a side cross-sectional view of the lure of FIG. 3 taken from the line 4-4.

FIG. 5 is a side cross-sectional view of the body of the lure in FIG. 4.

FIG. 6 is a side elevation view of the dowel and hook of FIG. 1.

FIG. 7 is an exploded view of the dowel and hook of FIG. 6.

FIG. 8 is side elevation view of alternative embodiment of a lure.

FIG. 9 is a top plan view of the lure of FIG. 8.

FIG. 10 is a side cross-sectional view of the lure of FIG. 9 taken from the line 10-10 with the hook pulled out.

FIG. 11 is a side cross-sectional view of the lure of FIG. 9 taken from the line 10-10 with the hook pushed in.

FIG. 12 is a rear perspective view of the lure of FIG. 8.

FIG. 13 is a side elevation view of another alternative embodiment of a lure.

FIG. 14 is a top plan view of the lure of FIG. 13.

FIG. 15 is a side perspective view of another embodiment of a lure.

FIG. 16 is a side perspective view of another embodiment of a lure.

FIG. 17 is a side perspective view of another embodiment of a lure.

### DETAILED DESCRIPTION

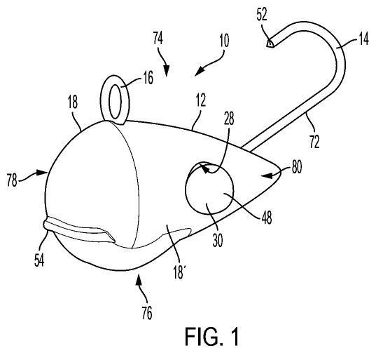

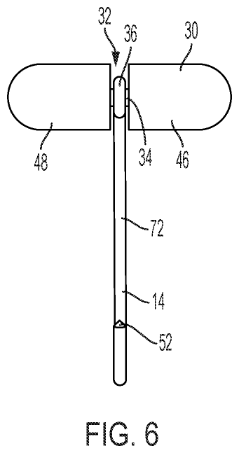

As shown in FIGS. 1-7, a lure 10, for example a jig, includes a frame or body 12 and a hook 14 and eyelet or line tie 16 connected or attached to the body. The eyelet 16 can be used to attach the lure 10 to fishing line. In one embodiment, the body 12 can be formed from tungsten, which provides the advantages of being a heavier material so it sinks faster and is noncorrosive. However, other materials known in the industry could be used, for example, lead, brass, zinc, stainless steel, etc., the use of which would not defeat the spirit of the invention.

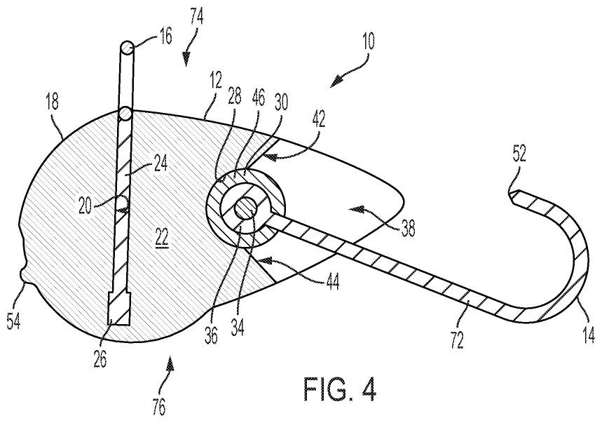

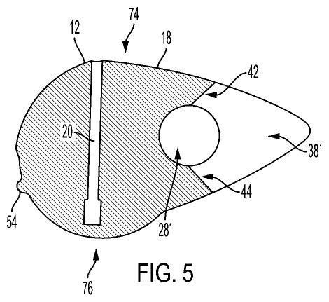

In one embodiment, the body 12 is formed from two portions 18, 18′ that are attached together such as by welding or soldering around the exterior perimeter. The body 12 can be sanded and painted if desired. One or both of the portions 18, 18′ can include recesses and/or pockets to accommodate features or accessories. For example, as seen in FIG. 5, one of the portions 18 of the body 12 can include a pocket 20 formed in the interior surface 22. As seen in FIG. 4, the eyelet 16 includes a stem 24 with a collar 26 that is located in the pocket 20 such that when the two portions 18, 18′ are attached, the eyelet 16 is attached to the body 12. The collar 26 prevents the eyelet 16 from being pulled out or disconnected from the body 12. Other means are known for attaching an eyelet to a body, the use of which would not defeat the spirit of the invention, including integrally forming, welding, screwing, etc.

The body 12 also has a bore 28 formed therein, such as by having a first bore 28′ in the first portion 18 of the body and a second bore 28″ in the second portion of the body 18′ that line up when the two portions are attached to form the bore 28. The bore 28 can be configured to receive a dowel 30.

The dowel 30 includes a reduced diameter or portion 32 with a pin 34. The reduced portion 32 can be sized and configured to accommodate the loop or enlarged end 36 of the hook 14 and the pin 34 can be sized and configured to fit within the loop 36 to attach the hook 14 to the dowel 30 and, thereby, rotatably attach the hook to the body 12. This attachment allows the hook 14 to rotate around the pin 34 and with respect to the body 12. In one embodiment, the dowel 30 is made from a brass material. The brass material will look different than the body 12 and may appear to be eyes of a live bait or otherwise attractive to a fish. However, other materials known in the industry could be used, for example, tungsten, lead, stainless steel, plastic, polyoxymethylene, acetal homopolymer, etc., the use of which would not defeat the spirit of the invention.

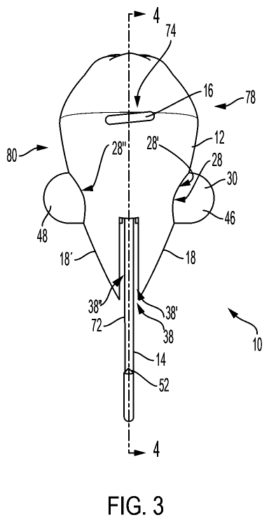

The body 12 can also have a notch 38 formed in the rear portion thereof. The notch permits the hook 14 to swing up and down, as seen in FIG. 3. For example, a first notch 38′ may be formed in the first portion 18 of the body 12 (as seen in FIG. 5) and a second notch 38″ (as seen in FIG. 3) may be formed in the second portion 18′ of the body which line up when the two portions are attached to form the notch 38. Alternatively, the body could be integrally formed and the bore 28 and/or notch 38 created after forming the body.

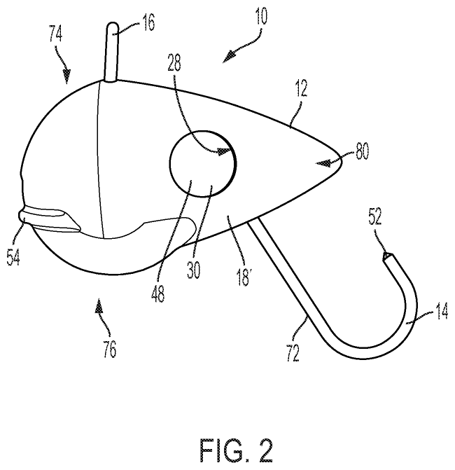

The notch 38 may also have a one or more stop surfaces. In the embodiment seen in FIG. 4, the notch 38 has an upper stop surface 42 and lower stop surface 44. The stop surfaces 42, 44 can define the notch 38 and limit the rotation of the hook 14 in a first direction and a second direction and therebetween. For example, the first or lower stop surface 44 can define a first end of the notch 38. The hook 14 is prevented from further rotation in a first or downward direction when the hook contacts the lower stop surface 44 and the tip 52 is in a first position pointed upwards, such as seen in FIG. 2.

The hook 14 is prevented from rotating further upwards when the shank 72, for example, contacts the second or upper stop surface 42 and the tip is a second position not pointed upwards (e.g. downwards) such as seen in FIG. 1. The one or more stop surfaces can be positioned to provide the desired amount of rotation for the hook 14 which, in the example embodiment, permits about ninety degrees of rotation.

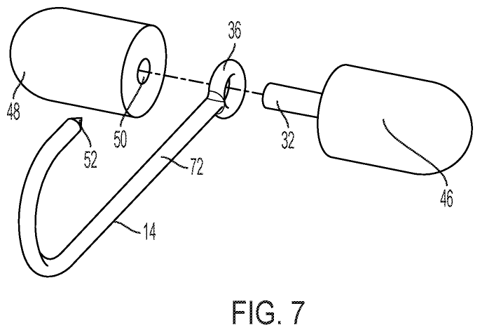

In one embodiment seen in FIG. 7, the dowel 30 is formed from a first or male portion 46 and a second or female portion 48. The female portion 48 has a blind bore or hole 50 formed therein configured to receive an end of the pin or peg 34 on the male portion 46. The loop 36 of the hook 14 may be inserted through the notch 38 and into the bore 28. The male portion 46 can be inserted into the hole 28 from a first side of the body 12 such that the pin 34 extends through the loop 36. The female portion 48 can be inserted into the hole 28 from the second side such that the blind bore 50 receives the pin 34. The male portion 46 may be attached to the female portion 48 such as by being press fit. The hook 14 thereby holds the dowel 30 in the hole 28. Other means are known for attaching two portions of a dowel and/or a dowel to a body, such as, for example, gluing, screwing, welding, pressure fitting, etc., the use of which would not defeat the spirit of the invention.

The lure 10 could be made, for example, by forming a body 12 with a bore 28 and a notch 38 formed therein. Inserting an end 36 of a hook 14 through the notch 38 and into the bore 28 such that a portion of a shank 72 of the hook is in the notch and a tip 52 of the hook is located outside of the bore, notch and body. Inserting a first portion 46 of a dowel 30 through a first side of the bore 28 such that a peg 34 of the first portion extends through the end 36 of the hook 14. Inserting a second portion 48 of the dowel 30 through a second side of the bore 28 such that the peg 34 is received in a hole 50 formed in the second portion and the hook 14 is rotatably attached to the body 12.

Alternatively, the pin 34 could be positioned in a hole or holes 28 in the first 18 and second portion 18′ of the body 12 or one of the first or second portions could include the pin 34 and the other of the first and second body could include a hole to receive an end of the pin.

In some current jigs, the hook is fixedly attached to the jig such that the point or tip of the hook is pointed towards the front of the jig and generally above the shank of the hook. When a fish strikes or bites the lure, the direction of such hooks may not be in a good position to engage the fish's mouth and the fish may get away even though it bit the jig. In the embodiment shown in FIGS. 1-4, the hook 14 may generally rotate downwards so that the tip 52 of the hook is pointed upwards, as seen in FIG. 2, to better position the hook to engage the fish's mouth when it strikes the lure or jig 10. The rotating ability of the hook 14 also provides more action to the jig 10, such as when a plastic worm or grub is added to the hook. As the fisherman or woman bobs or jerks the jig up and lets the jig sink back down, the hook will swing down and up making the jig appear more life like and attractive to fish.

The hook 14 is also permitted to move to better engage the fish's mouth depending on what angle the fish strikes the jig 10. Rotatably attaching the hook 14 to the body 12 also permits live bait, such as worms, smaller fish, etc., attached to the jig 10, such as on the hook, to be able to move more which attracts more fish. Also, when a fisherman or woman pulls the rod and line away from the fish, there is a delay which allows the body 12 and hook 14 to align and creates additional momentum further improving hook penetration in a fish's mouth.

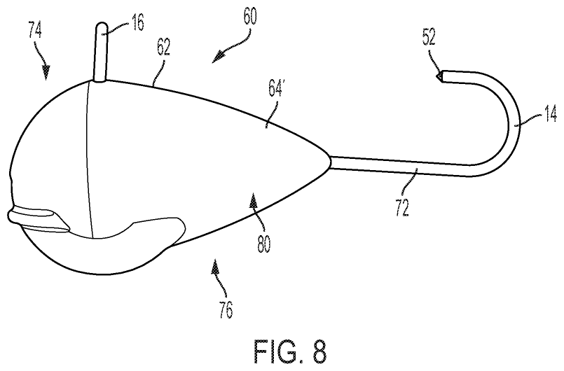

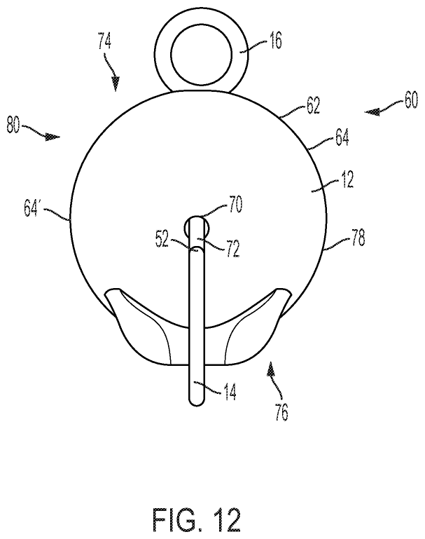

In an alternative embodiment, as seen in FIGS. 8-12, the jig 60 includes a hook 14 that can slide within the body 62 of the jig. In one embodiment, the body 62 is formed from two portions 64, 64′ that are attached together as discussed above with respect to the portions 18, 18′ of the jig 10. The jig 60 may also have any eyelet 16 which can be attached to the body 62 as discussed above with respect to the jig 10.

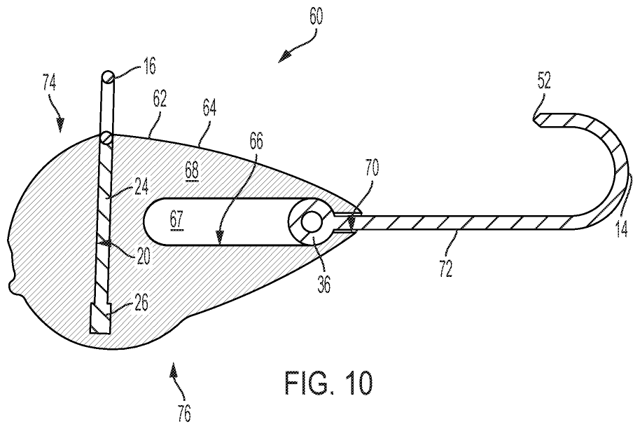

One or both of the portions 64, 64′ can include recesses and/or pockets to accommodate features or accessories. For example, as seen in FIG. 10, the body 62 can include an interior cavity or channel 66 formed therein. In one embodiment a first portion 64 of the body 62 can include a first interior cavity or channel 67 formed in the interior surface 68 and a second portion 64′ of the body 62 can include a second channel formed in the interior surface. When the first portion 64 is attached to the second portion 64′, a portion of the interior surface 68 of the first portion 64 contacts the a portion of the interior surface of the second portion 64′ and the first channel 67 and second channel form the interior cavity 66.

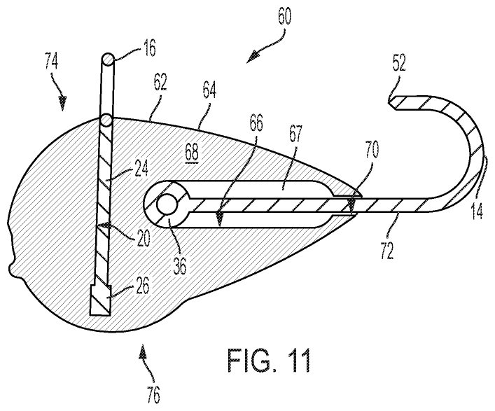

The interior cavity 66 is configured to receive the loop 36 of the hook 14 and permit the loop and the hook to move such that the tip 52 of the hook can be moved closer to the body 12, such as in a first position (see FIG. 11), or further away from the body 12, such as in a second position (see FIG. 10). In one embodiment, when the tip 52 is in the first position, closer to the body 12, the loop 36 of the hook 14 is located adjacent to the first end of the interior cavity 66 (and is closer to the front side of the body 62). When the tip 52 is in the second position, further away from the body 12, the loop 36 of the hook 14 is located adjacent to the second end of the interior cavity 66 (and is further away from the front side of the body 62). In this embodiment, the hook 14 is prevented from rotating when the tip is moved between the first and second positions such that the tip 52 is above the shank 72 and in position to engage a fish's mouth.

The jig 60 can be made, for example, by forming a first portion 64 having a first channel 67 formed in an interior surface 68 of the first portion and forming a second portion 64′ having a second channel formed in an interior surface of the second portion. Inserting at least a portion of a hook 14, for example, the loop 36 and a portion of the shank 72, in the first channel 67 such that a tip 52 of the hook is located outside of the first channel. Attaching the interior surface 68 of the first portion 64 to the interior surface of the second portion 64′ such that the loop 36 is held in the channel 66 and can move within the channel. An eyelet can be attached to one of the first portion 64 or second portion 64′ before the first portion is attached to the second portion.

The body 62 or the first portion 64 and/or second portion 64′ also include a hole or groove 70 formed therein extending from the interior cavity 66 to the exterior surface of the body. The groove 70 is configured, when the two portions 64, 64′ are combined, to permit the shank 72 of the hook 14 to move or slide therein or extend therethrough, but is too small to permit the loop 36 to enter or fit through, thereby holding the loop in the interior cavity 66. The interior cavity 66 is also sized to hold the loop 36 and, thereby, the hook 14 and point 52 in one orientation.

When a fish strikes the jig 60, the hook 14 (with or with out live bait) can slide out of the body 12 to allow the fish to get a better hold on the hook before a fisherman or woman jerks the rod up causing the line to pull the jig 60 and hook 14 away from the fish to engage the hook in the fish's mouth. This allows the jig 60 to look more like live bait to fish than if the hook 14 was extended further out. Permitting the hook 14 to be pulled out creates a bigger hook gap, the distance between the tip of the hook 52 and the body 62, which can be helpful in hooking the fish. The hook 14 being able to be pulled out of the body 62 also creates a delayed reaction between the time the fisherman or woman pulls the rod and line away from the fish and when the hook starts to move which creates additional momentum improving hook penetration in a fish's mouth.

Some hooks available have a loop that is orientated out of plane with the rest of the hook. This out of plane orientation is generally rotated ninety degrees from the loop shown in FIG. 10. Alternatively, in order to cooperate with more hooks, the interior cavity 66 could be configured to receive an out of plane orientated loop.

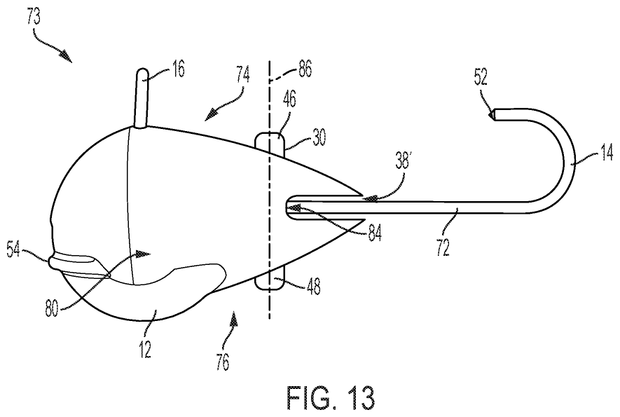

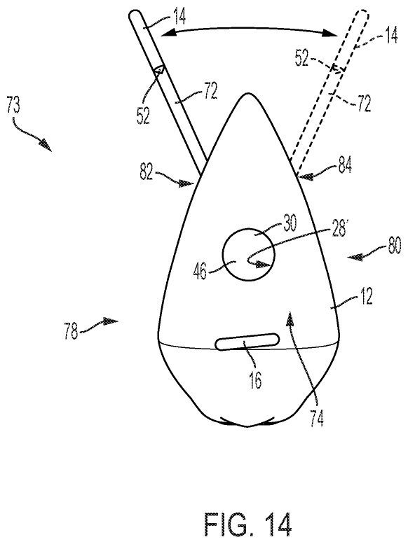

In another alternative embodiment, the hook 14 could be permitted to rotate left and right. In FIGS. 13-14, the bore 28 extends from a top side 74 of the jig 73 to the bottom side 76 of the jig and has a vertical longitudinal axis 86. The dowel 30 is positioned in the bore 28 to rotatably attach the hook 14 to the body 12. In the embodiment, the hook 14 has an out of plane orientated loop 36, as described above with respect to the jig 60, to receive the vertically oriented dowel.

The notch 38 as seen in FIG. 13 is horizontal, extending from a first side 78 of the jig to a second side 80 of the jig, as compared with the notch 38 of the previously described jig 10 which is perpendicular, extending from the top side 74 of the jig to the bottom side 76 of the jig. The jig 73 has a first stop surface 82 formed in the body 12 on a first side 78 of the bore 28 and a second stop surface 84 formed in the body on a second side 80 of the bore to limit the rotation of the hook 14.

The hook 14 of the jig 73 is permitted to move to better engage the fish's mouth depending on what angle the fish strikes the jig 73. Rotatably attaching the hook 14 to the body 12 also permits live bait, such as worms, smaller fish, etc., attached to the jig 73, such as on the hook, to be able to move more which attracts more fish. The hook movement also permits a bigger hook gap as discussed above with regards to the jig 60. Because some fish eat prey head first and attack from below the prey, the hook 14 of the jig 73 improves hook penetration. For example, when a fisherman or woman pulls the rod and line away from the fish, there is a delay which allows the body 12 and hook 14 to align and creates additional momentum further improving hook penetration in a fish's mouth.

The exterior surface of the body or portions could include features to make the lure or jig look like the live bait it is attempting to mimic. For example, the front of the body 12 could include a mouth 54, as seen in FIG. 1, although other features could be used, for example, texturing of the body to resemble scales or reflect light, fins, eyes, legs, etc., painting, epoxying, etc., without defeating the spirit of the invention. Such features could be molded in the body or added thereto.

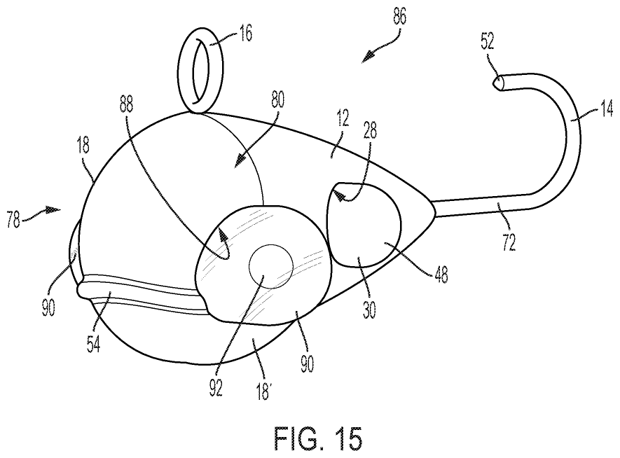

As discussed above, one embodiment includes a moving eye such as that taught in U.S. Pat. Nos. 10,575,506 and 10,244,741. The jig 86 seen in FIG. 15 is similar to that see in FIGS. 1-3, but has a hole or bore 88 formed in the body therein in the general location of where an eye would be of the live bait which the jig 86 is attempting to mimic. A tube 90 is located or positioned in the hole 88. The tube 90 extends and is visible from a first side 78 of the body 88 to, and is visible from, the second side 80 of the body. The tube 90 can include one or more noise making elements 92, e.g. balls or ball bearings, located in the tube that make a noise and vibration when they contact each other and/or the tube. The tube 90 may be made from a material that permits light through the material such that at least one ball 92 is visible through the tube when the at least one ball is located near one of the first end and second ends of the tube. In one embodiment, the tube 90 is fixed in the hole 88 such as by epoxying, gluing, ultra or sonic binding, friction, welding, snap-fit, etc., the use of which would not defeat the spirit of the invention.

To permit space for the bore 88 and tube 90, the eyelet 16 could have a shortened stem 24 and collar 26 or no stem and collar such as having a screw like attachment or even welded directly to the top of the body. Other means of attaching an eyelet to a body are known in the art, the use of which would not defeat the spirit of the invention.

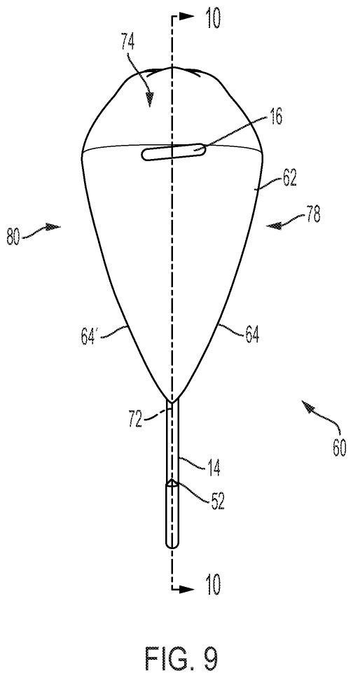

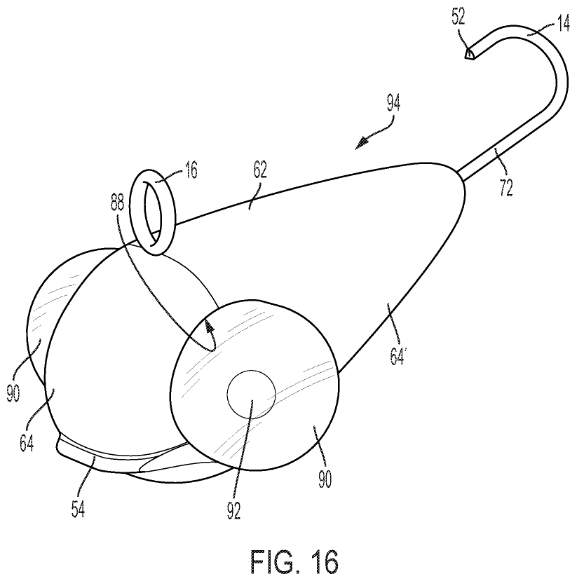

The jig 94 seen in FIG. 16 is similar to that see in FIGS. 9-12, but has a hole or bore 88 formed in the body and a tube 90 in the hole 88 with one or more noise making elements 92 as described above with regards to the jig 86.

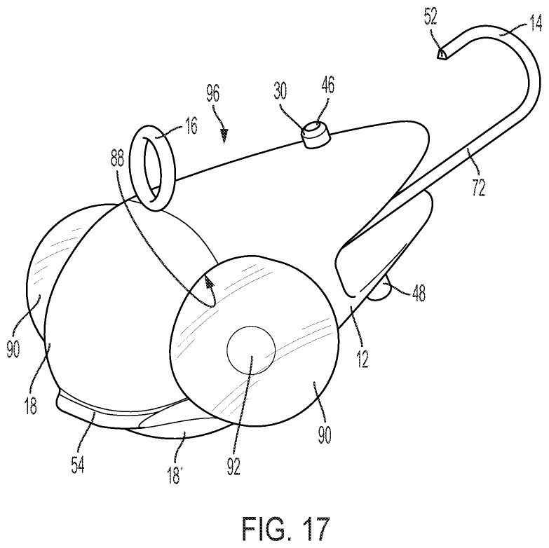

The jig 96 seen in FIG. 17 is similar to that see in FIGS. 13-14, but has a hole or bore 88 formed in the body and a tube 90 in the hole 88 with one or more noise making elements 92 as described above with regards to the jig 86.

Although the invention has been herein described in what is perceived to be the most practical and preferred embodiments, it is to be understood that the invention is not intended to be limited to the specific embodiments set forth above. Rather, it is recognized that modifications may be made by one of skill in the art of the invention without departing from the spirit or intent of the invention and, therefore, the invention is to be taken as including all reasonable equivalents to the subject matter of the appended claims and the description of the invention herein.

What is claimed is:

1. A lure comprising:
a body with a bore and a notch formed therein;
an eyelet attached to the body;
a dowel positioned in the bore; and
a hook having a shank and a tip, the hook attached to the dowel such that at least a portion of the shank extends through the notch and the tip is located outside of the body;
wherein the hook is attached to the dowel such that the hook may rotate with respect to the body between a first position and a second position;
wherein the tip cannot be located inside the body when the hook is rotated; and
wherein the hook is not configured to be held in the first position and the hook is not configured to be held in the second position.

2. (canceled)

3. (canceled)

4. (canceled)

5. (canceled)

6. (canceled)

7. The lure of claim 1, wherein the dowel has a reduced portion and the hook is attached to the reduced portion of the dowel.

8. The lure of claim 7, wherein the dowel further comprises:
a first portion with a peg; and
a second portion with a hole formed therein, the hole sized to receive an end of the peg;
wherein the peg extends through a loop of the hook to attach the hook to the dowel.

9. The lure of claim 1, wherein the body is formed from a first portion attached to a second portion.

10. The lure of claim 1, Wherein the lure is a jig.

11. (canceled)

12. (canceled)

13. (canceled)

14. (canceled)

15. (canceled)

16. (canceled)

17. (canceled)

18. (canceled)

19. (canceled)

20. (canceled)

21. A lure comprising:
a body with a bore and a notch formed therein;
an eyelet attached to the body;
a dowel positioned in the bore; and
a hook having a shank and a tip, the hook attached to the dowel such that at least a portion of the shank extends through the notch and the tip is located outside of the body;
wherein the hook is attached to the dowel such that the hook may rotate with respect to the body;
wherein the body has a first stop surface to prevent e hook from further rotation in a first direction;
wherein the body has a second stop surface to prevent the hook from further rotation in a second direction;
wherein the hook is configured such that the tip is located outside of the body when the hook moved between the first stop surface and second stop surface; and
wherein the hook is configured such that when the hook is adjacent the first stop surface, the tip is located outside the body on a first side of the body and when the hook is adjacent the second stop surface, the tip is located outside the body on a second side of the body.

22. A lure comprising:
a frame with a notch formed in a first end of the frame;
a line tie attached to the frame;
a dowel positioned in a bore formed in the frame; and
a hook having an end, a shank and a tip, the end of the hook attached to the dowel such that at least a portion of the shank extends through the notch and the tip is located outside of the frame;
wherein the hook is configured to rotate about the dowel;
wherein a distance from the tip to a location where the hook is attached to the dowel is a first distance;
wherein a distance from the bore to the first end of the frame farthest from the bore is a second distance; and
wherein the first distance is greater than the second distance.

23. The lure of claim 1, wherein the hook is configured such that when the hook is in the first position, the tip is located outside the body on a first side of the body and when the hook is in the second position; the tip is located outside the body on a second side of the body.

24. The e of claim 1, wherein the body has a first stop surface;
wherein the first stop surface defines an end of the notch; and
wherein the hook is prevented from further rotation in a first direction when the hook contacts the first stop surface.

25. The lure of claim 24, wherein the body has a second stop surface;
wherein the first stop surface and second stop surface define the notch;
wherein the hook is limited to rotation between the first stop surface and second stop surface.

26. The e of claim 25, wherein the bore has a vertical longitudinal axis;
wherein the first stop surface is formed in the body on a first side of the bore; and
wherein the second stop surface is formed in the body on a second side of the bore.

27. The lure of claim 25, wherein the hook is configured such that when the hook is adjacent the first stop surface, the tip is located outside the body on a first side of the body and when the hook is adjacent the second stop surface, the tip is located outside the body on a second side of the body.

28. The lure of claim 1, wherein the hook is configured to rotate about the dowel.

29. The lure of claim 21, wherein the hook is unrestricted when moved between the first stop surface and the second stop surface.

30. The lure of claim 29, wherein the hook is configured such that when the hook is in a first position, the hook is adjacent the first stop surface and when the hook is in a second position, the hook is adjacent the second stop surface.

31. The lure of claim 21, wherein the bore has a vertical longitudinal axis;
wherein the first stop surface is formed in the body on a first side of the bore; and
wherein the second stop surface is formed in the body on a second side of the bore.

32. The lure of claim 21, wherein the hook is configured to rotate about the dowel.

33. The lure of claim 22, wherein the hook is configured to be freely rotated between a first position and a second position.

34. The lure of claim 33, wherein the hook is configured such that when the hook is in the first position, the tip is located outside the frame on a first side of the frame and when the hook is in the second position, the tip is located outside the frame on a second side of the frame.

35. The lure of claim 22, wherein the frame has a first stop surface;
wherein the first stop surface defines an end of the notch; and
wherein the hook is prevented from further rotation in a first direction when the hook contacts the first stop surface.

36. The lure of claim 35, wherein the frame has a second stop surface;
wherein the first stop surface and second stop surface define the notch;
wherein the hook is limited to rotation between the first stop surface and second stop surface.

37. The lure of claim 36, wherein the bore has a vertical longitudinal axis;
wherein the first stop surface is formed in the frame on a first side of the bore; and
wherein the second stop surface is formed in the frame on a second side of the bore.

38. The lure of claim 37, wherein the hook is configured such that when the hook is adjacent the first stop surface, the tip is located outside the frame on a first side of the frame and when the hook is adjacent the second stop surface, the tip is located outside the frame on a second side of the frame.
